(19) United States
(12) Patent Application Publication
(10) Pub. No.: US 2016/0178151 A1
(43) Pub. Date: Jun. 23, 2016

(54) LIGHTING AND/OR SIGNALING DEVICE COMPRISING A PLURALITY OF LIGHT-EMITTING DIODES

(71) Applicant: Valeo Vision, Bobigny Cedex (FR)

(72) Inventor: Michael Maitre, Vaureal (FR)

(21) Appl. No.: 14/974,307

(22) Filed: Dec. 18, 2015

(30) Foreign Application Priority Data
Dec. 19, 2014 (FR) 1462956

(51) Int. Cl. F21S 8/10

(52) U.S. Cl. CPC F21S 48/1109; F21S 48/115; F21S 48/212; F21S 48/215

(57) ABSTRACT

A lighting and/or signaling device comprising a plurality of light-emitting diodes secured to a support made of plastic which has at least one three-dimensional zone in the form of a staircase made up of successive treads and risers in substantially perpendicular planes, each of the diodes being fixed respectively to one of the treads of the support, the diodes being powered by conductive metallic tracks.

The conducting tracks are formed by thicknesses of metal that differ according to whether the tracks extend along the treads or along the risers, the tracks arranged on a tread being produced by a thickness of metal encrusted into the volume of the plastic support, in housings formed in the thickness of the tread.

### CROSS-REFERENCE TO RELATED APPLICATIONS

This application claims priority to the French application 1462956 filed Dec. 19, 2014, which application is incorporated herein by reference and made a part hereof.

### BACKGROUND OF THE INVENTION

1. Field of the Invention

The present invention relates to a lighting and/or signaling device of the type comprising a plurality of light-emitting diodes. It relates more particularly to the support of these light-emitting diodes and to the specific three-dimensional shape of this support.

2. Description of the Related Art

In lighting and/or signaling modules, notably for motor vehicles, use is increasingly made of light-emitting diodes, notably because of the cost, autonomy and size advantages they present. These light-emitting diodes need to be powered by electric circuits carrying the current from a connector to the diode. These electric power supply circuits may be etched onto a printed circuit board or may, as is the case in more recent technology, be injected directly into or attached to the surface of a plastic component to form a molded interconnecting device (MID).

The use of light-emitting diodes in lighting and/or signaling modules has allowed motor vehicle designers to add a creative touch to the design of the lighting devices. Thus, the use of several light-emitting diodes allows changes to be made to the look as well as to the quality of the lighting of the device. Designers have also used three-dimensional components in order to arrange all of the diodes in a desired layout.

Thus, three-dimensional diode supports in the form of staircase treads are known, each of the diodes being positioned on one of these treads, all facing in the same direction. In order for all of the diodes therefore to be powered by the electric power supply circuit, the printed circuits need to be applied to each of the faces of the three-dimensional support. The use of rigid printed circuit boards attached to each of the faces is inconceivable because it involves a board bonding process that is too fiddly if the number of diodes is high. Moreover, electrical connection between flat boards is not assured and the rigidity of the printed circuit boards is somewhat incompatible with the desire for three-dimensional supports.

Document EP 2 141 406 describes how to obtain such a three-dimensional diode support and associated printed circuits by creating a molded interconnecting device, the conducting tracks being incorporated into the molded component by plastic injection molding. The molded interconnecting device is obtained by manufacturing techniques that are expensive and generate somewhat small thicknesses of metal. Now, when using high-powered diodes it is important to perform a heat treatment by using a sufficiently large thickness of metal. The techniques hitherto used for producing the molded interconnecting device, such as galvanizing each of the faces of the diode support then etching these faces using laser ablation, do not allow such thicknesses of metal to be achieved.

Flexible printed circuits manufactured using a printed circuit technology that involves using a plastics substrate onto which the circuits are screen printed are also known. These flexible printed circuits are able to adopt a specific shape for optimized integration thereof into the lighting and/or signaling module. The main problems with this type of embodiment are the cost, which is not compatible with the demand for mass-production applications to have a low cost price, and their lower strength.

### SUMMARY OF THE INVENTION

The present invention proposes a three-dimensional diode support obtained by manufacturing operations that are inexpensive, simple to put in place, and generate a diode support that has a high ability to cool the diodes.

To this end, the invention proposes a lighting and/or signaling device comprising a plurality of light-emitting diodes secured to a plastic support which has at least one three-dimensional zone in the form of a staircase made up of successive treads and risers in substantially perpendicular planes. The diodes are each fixed to one of the treads of the support and are powered and controlled by conducting metallic tracks. According to particularly advantageous features of the invention, the conducting tracks are formed by thicknesses of metal that differ according to whether they extend along the treads or along the risers. Thus, the tracks arranged on a tread around a light-emitting diode are produced by a thickness of metal encrusted at least in part into the volume of the plastic support, for example in notches or grooves formed in the thickness of the tread, whereas the tracks arranged along the risers are produced by a smaller overthickness of metal preferably which is attached onto the surface of the riser. Advantageously, the tracks arranged on the treads around the light-emitting diode are produced by hot-pressing a metallic sheet on each of these treads whereas the tracks arranged along the risers are produced by any other means. Alternatively, the tracks arranged on the treads around the light-emitting diode are produced by laser ablation of the support so as to create deep grooves in the surface, followed by metallization by autocatalytic deposition (or electroless plating) or by electrodeposition. Alternatively, these thicker tracks are done by plasma deposition. Thus the production of relatively thicker tracks by laser ablation followed by metallization or plasma deposition or hot pressing of a metallic sheet into the plastic support, using a method referred to as “hot embossing”, which makes it possible to produce thick metallization layers, which means to say layers extending to a depth and incorporated at least in part into the volume of the diode support, where they are needed, namely near the light-emitting diode which requires this heat treatment is advantageously combined with other manufacturing techniques as far as incorporating the printed circuits into the risers is concerned, these not having a diode and having only a geometric and electricity-conducting function.

According to a feature of the invention, the tracks arranged on the treads around the light-emitting diode have a thickness of at least 20 micrometers, preferably comprised between 20 and 200 micrometers. The tracks arranged along the risers have a thickness of about 10 to 12 micrometers.

According to various features of the invention, it is possible to conceive of the conducting tracks attached to the risers being so either using MID technology, such as the depositing of conducting ink, galvanization followed by laser ablation, since this surface, which does not support the diodes, does not require a significant thickness of metallization, or by simple connections that allow electrical interconnection of each of the treads together.

There is thus proposed a lighting and/or signaling device capable of meeting the design requirements of automotive designers since the diode support is three-dimensional, with a cost of producing the support for the diodes and the integrated circuits which is lower than that of a technique in which the entire support is galvanized for example, and that offers increased strength by comparison with embodiments using flexible printed circuit techniques.

According to various features of the invention:
the tracks arranged along the risers are attached to the risers by depositing ink. In this type of embodiment, droplets of overthickness are advantageously created at the junction between the treads and the risers to form electrical continuity between the tracks arranged on the treads and the tracks arranged on the risers.
the thickness of metal encrusted at least in part into the plastic forming the treads is greater than the thickness of metal added onto the plastic forming the surface of the risers.
the diodes and the conducting tracks are arranged on the same face of the diode support.
the treads, and, respectively, the risers, are arranged so that they extend in planes substantially parallel to one another.

The invention also relates to a lighting and/or signaling module comprising a housing closed by a protective outer lens and inside which are fixed a three-dimensional diode support as has just been described and a reflector designed to direct the beam of light from the diodes in the desired direction as it leaves the module. The diode support has a front face facing the reflector and to which the diodes are attached. Once again, these diodes are connected by electrically conducting tracks which have a greater thickness on the diode-bearing treads than on the risers.

The invention also relates to a method of obtaining a lighting and/or signaling device having a three-dimensional plastic support for a plurality of light-emitting diodes, in which the conducting tracks supplying power to the diodes are of thicknesses that differ according to whether these tracks extend along the treads or along the risers. According to a first alternative form, the tracks produced on the treads around the light-emitting diode are produced by embossing the support and by hot-pressing a metallic sheet into housings formed in the volume of the support, by the embossing, and the tracks produced along the risers are obtained by any other means, for example by a deposit of conducting ink. According to a second alternative form, the tracks arranged on the treads around the light-emitting diode are produced by laser or plasma ablation of the support so as to create deep grooves in the surface, followed by metallization by autocatalytic deposition or by electrodeposition. According to a third alternative form, the tracks are done by plasma deposition. Advantageously, the tracks encrusted into the material of the support at the treads and the tracks produced by depositing conducting ink along the risers are produced in two successive operations, the three-dimensional plastic support being turned between these two operations so that the tracks encrusted into the material of the support at the treads are produced in a given plane and so that the tracks produced by depositing conducting ink along the risers are produced in a substantially perpendicular plane.

According to one feature of the invention, these method steps are then followed by the connecting of the diodes on each of the treads of the support on which the printed circuit has been encrusted by the hot-pressing of a sheet.

In this way, the entire support is metalized in two successive steps for which access to the component is facilitated in each instance by the change in axis. It will be appreciated that the diode support has flat treads that are large enough that the step of hot-impressing the sheet onto the treads of the support can be performed correctly and it will be appreciated that the risers are intended to be covered metallically during the second, interconnection, step which requires the deposition of only a thin layer of metal, the need for heat treatment because of the heat given off by the light-emitting diode being catered for mainly by the thicker layer of metal arranged on the flat part of the treads.

These and other objects and advantages of the invention will be apparent from the following description, the accompanying drawings and the appended claims.

### BRIEF DESCRIPTION OF THE ACCOMPANYING DRAWINGS

The invention and ensuing advantages will now be described in the following detailed and nonlimiting description which refers to the attached drawings among which:

FIG. 1 is a perspective view of a lighting and/or signaling device according to the invention, associated with a reflector;

FIG. 2 is a perspective view of the device of FIG. 1, viewed from the other side, and showing the diode support equipped with the diodes and the printed circuits for powering these diodes; and

FIG. 3 is a schematic cross section of a detail of the diode support illustrated in FIG. 2, notably showing two light-emitting diodes of the plurality supported, and the conducting tracks associated with these two diodes and the interconnections thereof.

### DETAILED DESCRIPTION OF THE PREFERRED EMBODIMENTS

The lighting and/or signaling device according to the invention comprises a three-dimensional diode support 2 to which are attached a plurality of light-emitting diodes 4 each one connected by electrically conducting tracks 6 so as to transmit power and control information.

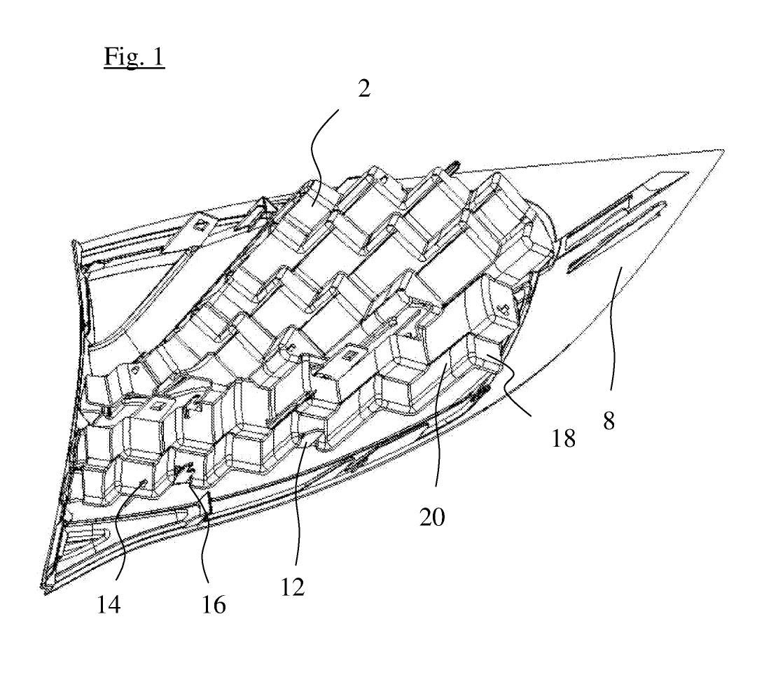

The device is particularly suited to being housed in a lighting and/or signaling module of motor vehicles, made up of a housing housing the diode support 3 and of a projection outer lens closing the housing and trapping the diode support 3. Furthermore, as illustrated in FIG. 1, the diode support 2 is designed in this lighting and/or signaling module to be positioned facing a reflector 8 which will make it possible to obtain the desired final orientation of the beam of light originating from the light-emitting diodes 4.

The diode support 3 has a front face 10, facing toward the reflector 8, the diodes 4 each being positioned on flat parts of this front face so that the beam of light leaving each of the diodes 4 is directed toward the wall of the reflector 8 opposite. It will be appreciated that the diode support 3, the light-emitting diodes 4 and the projector are arranged in such a way that the light emitted is emitted toward the projection outer lens, to illuminate or signal towards the outside of the vehicle. To this end, in the known way, the assembly formed by the reflector 8 and the diode support 3 is designed so that each of the diodes 4 is positioned at a focal point of the reflector 8. Indexing means are borne respectively by the diode support 3 and by the reflector 8 to ensure that the diodes 4 are positioned at these focal points. Lateral pegs 12 and pins 14 (both visible in FIG. 1) project out from the main plane of the reflector 8 and corresponding notches 16 (visible in FIGS. 1 and 2) are formed in the walls of the diode support 3 to form these indexing means. Steps are taken to ensure that the presence of the walls bearing the pegs 12 and the pins 14 does not impede the diffusion of the light leaving the diodes 4.

The diode support 3 of the device according to the invention has a three-dimensional zone in the form of a staircase, comprising a succession of treads 18 and of risers 20 arranged in substantially perpendicular planes. As illustrated in FIG. 2, the diode support 3 may be defined by several series of staircases 22 arranged one below the other. With reference to the longitudinal direction of emission of the diodes 4 arranged on the diode support 3, the treads 18 will hereinafter be referred to as being arranged in a transverse plane, with the risers 20 being said to be arranged in a longitudinal plane.

The light-emitting diodes 4 are arranged one by one on the treads 18, one diode 4 per tread 18. The diodes 4 are fixed by bonding to the front face of the diode support 3. The treads 18 are arranged in mutually parallel planes so that the beams originating from the diodes 4 extend substantially parallel to one another in the same direction.

It will be appreciated that the design of the diode support 3 component can be modified without departing from the scope of the invention and can, for example, have a greater or lesser number of treads 18 and therefore a greater or lesser number of light-emitting diodes 4. However, it is appropriate according to the invention for each of the treads 18 intended to accept a light-emitting diode 4 to have a surface, onto which the diode 4 is attached, that is sufficiently flat.

The conducting tracks 6 used to supply power to the diodes 4 and to communicate lighting control instructions extend continuously over the entire diode support 3, from one tread 18 to the next, via the risers 20.

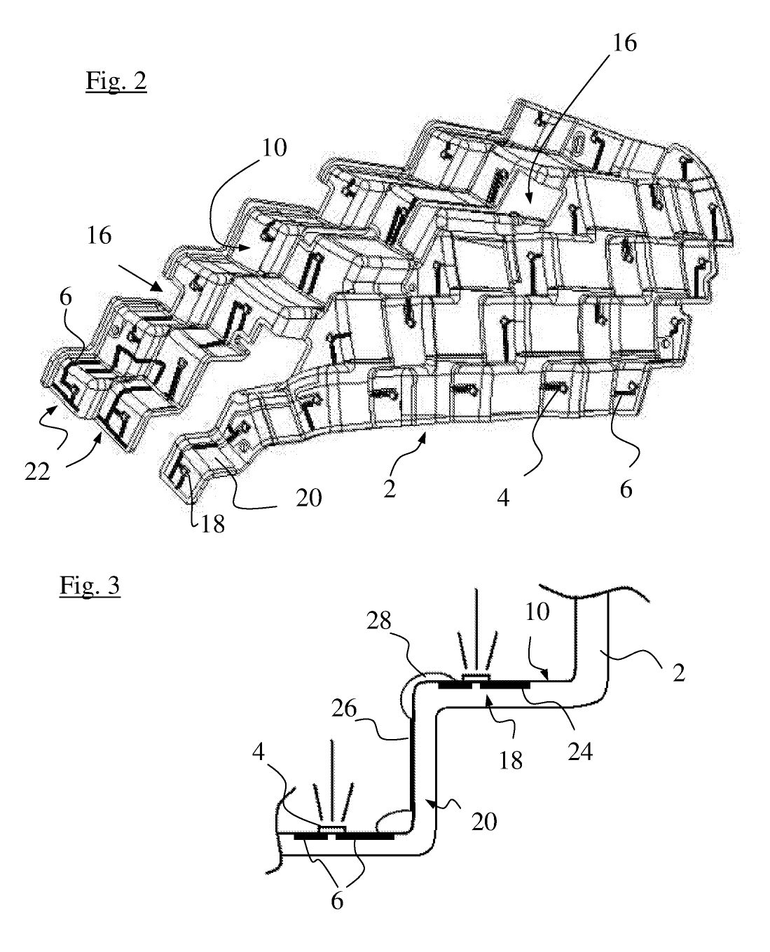

According to the invention, as can be seen in FIG. 3, the diode support 3 is characteristic in that the conducting tracks 6 are formed by thicknesses of metal that differ according to whether they are applied to the treads 18 or to the risers 20. In particular, the conducting tracks 6 extend at least in part into the volume of the plastic component, as encrusted into the material, or on the surface of this plastic component, as deposited onto the material, according to whether they are applied to the treads 18 or to the risers 20 and according to the technique used to create them.

Indeed, while it is true that the metallic conducting tracks 6 are conducting continuously over the entire circuit, it may be noted that the thickness of metallization used to create these conducting tracks 6 in or on the plastic of the diode support 3 differs according to whether it is applied to the treads 18 or to the risers 20. The thickness of metallization is greater on the treads 18, namely near each of the light-emitting diodes 4, than on the risers 20. As may have been specified earlier, the metal is used both for communicating information from the control module to each of the diodes 4 spread over the diode support 3 and also for the cooling of the diodes 4, the effectiveness of this cooling being proportional to the thickness of metal present near the diode 4. The greater the thickness of metal, the better the cooling.

This significant thickness of metal on the treads 18 is, according to a first alternative form, obtained by hot pressing a metallic film of the desired thickness, hence the need for correct flatness of the tread 18 that forms the face accommodating the diode 4. The hot-pressing of the metallic film onto the tread 18 is performed using a technique known by the name of “hot embossing” in which a metallic sheet having the desired thickness of metal is placed against each of the treads 18.

The first step in this technique is to place the untouched plastic diode support 3 in a framework that reproduces the three-dimensional staircase shape of the diode support 3, so that the latter can rest against the framework and maintain sufficient rigidity during the forthcoming pressing step.

The framework is oriented appropriately so that the plastic diode support 3 presents, in a manner that is apparent and suited to the application of the metallic sheet, the front face of each of the treads 18.

The metallic sheet is applied to the treads 18, to the front face designed to accept the diode 4 later. It is possible to provide just one single metallic sheet that covers the entire diode support 3, or to provide distinct metallic sheets each specific to the treads 18 and to the design of track 6 that is to be created on these treads 18.

A press is then applied to the diode support 3 trapping the metallic sheet (or sheets). That face of the press that is made to come into contact with the metallic sheet has ribs which project from this face in a layout corresponding to the arrangement of the conducting tracks 6 that are to be integrated onto the steps of the diode support 3.

It is possible without departing from the scope of the invention to contemplate a press that has a two-dimensional flat contact face which is brought onto each of the steps and for each one creates the same arrangement of conducting tracks 6, or alternatively a press that has a three-dimensional contact face that deforms all of the treads 18 in a single hit, this being possible because of the parallel arrangement of the planes in which the treads 18 extend.

Movement of the press stops when the contact face is in abutment with the front face of the diode support 3. The ribs projecting from the contact face therefore deform the front face of the diode support 3 at the treads 18, thereby creating housings 24 that adopt the shape of grooves or notches (visible in FIG. 3) the dimensions and layout of which correspond to those of the ribs. It will be appreciated, as has been indicated schematically by way of example, that the housings formed on one and the same tread 18 may have different dimensions and depths, notably depending on their proximity to the light-emitting diode 4 intended to be bonded to this tread 18, and that the corresponding ribs formed as projections on the plate press may therefore have shapes and dimensions that differ from one another.

Through this hot pressing, the metallic sheet is deformed to follow the downward movement of the press and is driven into the thickness of the diode support 3 into each of the grooves created. The surplus metallic sheet that has not been integrated into the volume of the diode support 3 then needs to be removed.

This hot pressing technique, used conventionally for two-dimensional components, is combined here with another method for creating electrically conducting tracks 6 on the risers 20 and ensuring the electrical continuity between the printed circuits attached to the treads 18. This other method may be selected from several known techniques, it being understood that the requirement for a significant thickness of metal applies only to the depositing of metal on the treads 18.

As FIG. 3 illustrates, this electrical continuity is advantageously achieved by depositing a layer of conducting ink 26 on the risers 20. This makes it possible to control the actual surface on which conducting tracks 6 are deposited and limit it to the sole function of providing the electrical continuity of the conducting tracks 6 injected into the volume of the treads 18, because there is no need here to perform a diode-cooling function. Furthermore, the technique of depositing ink allows the junctions between the perpendicular planes to be created easily by forming overthickness droplets 28.

The result of this is that, at tread level, the conducting tracks 6 are integrated at least in part into the volume of the diode support 3, encrusted in the diode support 3, whereas at riser level, the conducting tracks 6 are pressed firmly against the front face of the diode support 3, as an overthickness. As may have been described earlier, the conducting tracks 6 encrusted into the volume of the diode support 3 at the treads 18 advantageously have a thickness that is greater than that of the conducting tracks 6 pressed against the diode support 3 at the risers 20.

It was seen earlier that the treads 18 that accept the diodes 4, and are therefore produced by the same hot pressing method, are all substantially parallel and arranged in the same transverse plane. The hot-pressing can thus be carried out as described hereinabove, in a single operation or in as many operations as there are treads 18, but without, however, moving the support component. This is particularly advantageous since the costs of creating the machine are limited.

All that is then required in the method for producing the device according to the invention is for the machine to be turned when all the treads 18 that are to bear diodes 4 have been encrusted with electric circuits, so that the deposition of conducting layers for creating the interconnections can then be performed on the risers 20 in one and the same continuous step.

In another alternative form, the conducting tracks 6 produced on the treads 18 around the light-emitting diode 4 are produced by laser ablation of the diode support 3 so as to create deep grooves in the surface, followed by metallization using autocatalytic deposition (or electroless plating) or electrodeposition, for instance according to the process disclosed in the patent application U.S. 2014/0037414.

According to a last alternative form, the conducting tracks 6 produced on the treads 18 around the light-emitting diode 4 are produced by plasma deposition.

The description that has just been given clearly explains the advantages of the invention, particularly the reduction in the costs of obtaining the three-dimensional component in order to meet the requirements of automotive manufacturers. Combining two methods of encrusting or depositing metallic elements with respect to a plastic component, chosen correctly according to the zone to which these electrical circuits are to be applied, makes it possible to avoid the excessively high manufacturing costs of a chemical bath in which the plastic support component might be dipped in its entirety and also makes it possible to avoid obtaining a component with excessively small thicknesses of metal over its entire metalized face, as this could cause the component to overheat and the lighting and/or signaling device to fail. It is particularly appropriate to use the methods referred to as “hot embossing” for the flat surfaces bearing the diodes, and to combine this production method with a more conventional method that is less expensive and generates less metal for the interconnection zones. It should be noted that the “hot embossing” technique is known to be effective on two-dimensional components which means that a person skilled in the art would, unless he had conceived of using this technique in combination with other techniques for metalizing the interconnections, have not seen any benefit in using this technique in the context of a three-dimensional support.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A lighting and/or signaling device comprising a plurality of light-emitting diodes secured to a three-dimensional plastic support which has at least one three-dimensional zone in the form of a staircase made up of successive treads and risers in substantially perpendicular planes, each of said plurality of light-emitting diodes being fixed respectively to one of said treads of said three-dimensional plastic support, said plurality of light-emitting diodes being powered by conductive metallic conducting tracks, wherein said conducting tracks are formed by thicknesses of metal that differ according to whether said conducting tracks extend along said treads or along said risers, said thicknesses of metal encrusted into the plastic forming said treads is greater than a thickness of metal added or encrusted onto the plastic forming a surface of said risers, said conducting tracks arranged on said tread around at least one of said plurality of light-emitting diodes being produced by a thickness of metal encrusted into a volume of said three-dimensional plastic support, in housings formed in a thickness of said tread, whereas said conducting tracks arranged along said risers are produced by an overthickness of metal which is attached or encrusted onto said surface of the said riser.

2. The lighting and/or signaling device according to claim 1, wherein said conducting tracks arranged on said tread around said at least one of said plurality of light-emitting diodes are produced by hot-pressing a metallic sheet onto said tread whereas said conducting tracks arranged along said risers are produced by any other means so as to allow continuity of the conduction of electricity between each of said treads.

3. The lighting and/or signaling device according to claim 1, wherein said conducting tracks arranged along said risers are attached to risers by injecting a layer of ink.

4. The lighting and/or signaling device according to claim 3, wherein droplets of overthickness are formed at a junction between said treads and risers to form electrical continuity between said conducting tracks arranged on said treads and said conducting tracks arranged on said risers.

5. The lighting and/or signaling device according to claim 1, wherein said conducting tracks arranged on said tread around said at least one of said plurality of light-emitting diodes are produced by laser or plasma ablation of said three-dimensional plastic support so as to create deep grooves in said surface, followed by metallization by autocatalytic deposition or by electrodeposition.

6. The lighting and/or signaling device according to claim 1, wherein said plurality of light-emitting diodes and said conducting tracks are arranged on a same face of said three-dimensional plastic support.

7. The lighting and/or signaling device according to claim 1, wherein said treads are arranged so that they extend in planes substantially parallel to one another.

8. The lighting and/or signaling device according to claim 1, wherein said risers are arranged so that they extend in planes parallel to one another.

9. A method of obtaining a lighting and/or signaling device having said three-dimensional plastic support for said plurality of light-emitting diodes according to claim 1, in which said conducting tracks supplying power to said plurality of light-emitting diodes are of thicknesses that differ according to whether said conducting tracks extend along said treads or along said risers, said conducting tracks produced on said treads around said plurality of light-emitting diodes being produced by embossing said three-dimensional plastic support and by hot-pressing a metallic sheet into said housings formed in the volume of said three-dimensional plastic support, whereas said conducting tracks produced along said risers are obtained by any other means and are of lesser thickness.

10. The method according to claim 9, in which said tracks attached along said risers are produced by depositing conducting ink.

11. The method according to claim 10, in which said conducting tracks injected into a material of said three-dimensional plastic support at said treads and said conducting tracks produced by depositing conducting ink along said risers are produced in two successive operations, said three-dimensional plastic support being turned between these two operations so that said conducting tracks injected into said material of said three-dimensional plastic support at said treads are produced in a given plane and so that said conducting tracks produced by depositing conducting ink along said risers are produced in a substantially perpendicular plane.

12. The lighting and/or signaling device according to claim 2, wherein said conducting tracks arranged along said risers are attached to said risers by injecting a layer of ink.

13. The lighting and/or signaling device according to claim 2, wherein said plurality of light-emitting diodes and said conducting tracks are arranged on a same face of said three-dimensional plastic support.

14. The lighting and/or signaling device according to claim 3, wherein said plurality of light-emitting diodes and said conducting tracks are arranged on a same face of said three-dimensional plastic support.

15. The lighting and/or signaling device according to claim 4, wherein said plurality of light-emitting diodes and said conducting tracks are arranged on a same face of said three-dimensional plastic support.

16. The lighting and/or signaling device according to claim 5, wherein said plurality of light-emitting diodes and said conducting tracks are arranged on a same face of said three-dimensional plastic support.
